(19) United States
(12) Patent Application Publication
(10) Pub. No.: US 2025/0013423 A1
(43) Pub. Date: Jan. 9, 2025

(54) METHOD OF CONTROLLING HOME APPLIANCE AND ELECTRONIC DEVICE FOR PERFORMING THE METHOD

(71) Applicant: Samsung Electronics Co., Ltd., Suwon-si (KR)

(72) Inventors: Byeongcheol YOON, Suwon-si (KR); Yesol LEE, Suwon-si (KR); Younghak KONG, Suwon-si (KR); Hyelim PARK, Suwon-si (KR); Soohyun SUNG, Suwon-si (KR); Myoungsoo JANG, Suwon-si (KR); Chihong CHO, Suwon-si (KR); Juhyeon PAENG, Suwon-si (KR)

(21) Appl. No.: 18/638,108

(22) Filed: Apr. 17, 2024

Related U.S. Application Data
(63) Continuation of application No. PCT/KR2024/004101, filed on Mar. 29, 2024.

(30) Foreign Application Priority Data
Jul. 4, 2023 (KR) 10-2023-0086772
Aug. 30, 2023 (KR) 10-2023-0114260

(51) Int. Cl. G06F 3/16; G10L 25/66; G10L 25/72

(52) U.S. Cl. CPC G06F 3/165; G06F 3/162; G10L 25/66; G10L 25/72

(57) ABSTRACT

A method of controlling a home appliance, and an electronic device for performing the method are provided. The method includes obtaining sleep information of a user and operation information of each of a plurality of home appliances, determining a noise source device which causes noise outside a deep sleep range, from among the plurality of home appliances, at a time when a sleep phase of the user included in the sleep information is changed, and controlling operation of the noise source device so that noise caused from the noise source device is generated within the deep sleep range.

### CROSS-REFERENCE TO RELATED APPLICATION(S)

This application is a continuation application, claiming priority under § 365 (c), of an International application No. PCT/KR2024/004101, filed on Mar. 29, 2024, which is based on and claims the benefit of a Korean patent application number 10-2023-0086772, filed on Jul. 4, 2023, in the Korean Intellectual Property Office, and of a Korean patent application number 10-2023-0114260, filed on Aug. 30, 2023, in the Korean Intellectual Property Office, the disclosure of each of which is incorporated by reference herein in its entirety.

### TECHNICAL FIELD

The disclosure relates to a method of controlling a home appliance and an electronic device for performing the method. More particularly, the disclosure relates to a method of controlling a plurality of home appliances so as not to disturb a user's sleep, and an electronic device for performing the method.

### BACKGROUND ART

A plurality of devices located and operating inside a user's house may cause noise. For example, a plurality of home appliances, such as an air conditioner, a refrigerator and a television (TV) may be located in the house. The air conditioner may cause noise while a drain pump therein is operating. The refrigerator may cause noise while a compressor therein is operating. The TV may cause noise by outputting sound while displaying images.

In order not to disturb the user's sleep, the plurality of devices, such as home appliances may operate in a low-noise mode to reduce the noise by restricting the operation capabilities or operation performance. For example, in a case of setting sleeping hours, the plurality of devices may operate in the low-noise mode during the time set to the sleeping hours. It may not, however, be easy to identify a device that is a source of noise that disturbs the user's sleep among the plurality of devices. Hence, as the plurality of devices may operate in the low-noise mode altogether, overall use efficiency of the plurality of devices may be lowered. Furthermore, it may not be easy to determine to what extent operation capabilities or operation performance of each of the plurality of devices need to be restricted so as not to disturb the user's sleep. In this case, the operation capabilities or operation performance of each of the plurality of devices may not be restricted enough to make it easy to substantially help with the user's sleep.

### DISCLOSURE

### Technical Solution

In accordance with an aspect of the disclosure, a method of controlling a home appliance is provided. The method includes obtaining sleep information of a user and operation information of each of a plurality of home appliances in a house, determining a noise source device which causes noise outside a deep sleep range, from among the plurality of home appliances, at a time when a sleep phase of the user included in the sleep information is changed, and controlling operation of the noise source device so that noise caused from the noise source device is generated within the deep sleep range.

In accordance with another aspect of the disclosure, an electronic device is provided. The electronic device includes a communication module, memory storing one or more computer programs, and one or more processors communicatively coupled to the communication module and the memory, wherein the one or more computer programs include computer-executable instructions that, when executed by the one or more processors, cause the electronic device to obtain sleep information of a user and operation information of each of a plurality of home appliances in a house, through the communication module, determine a noise source device which causes noise outside a deep sleep range, from among the plurality of home appliances, at a time when a sleep phase of the user included in the sleep information is changed, and to control operation of the noise source device so that noise caused from the noise source device occurs within the deep sleep range.

In accordance with another aspect of the disclosure, a server is provided. The server includes a communication module, memory storing one or more computer programs, and one or more processors communicatively coupled to the communication module and the memory, wherein the one or more computer programs include computer-executable instructions that, when executed by the one or more processors, cause the server to receive, from an electronic device, obtained information including at least part of sleep information of a user and operation information of each of a plurality of home appliances in a house, determine, based on the received obtained information, a noise source device which causes noise outside a deep sleep range, from among the plurality of home appliances, at a time when a user's sleep phase of the user included in the sleep information is changed, and send information identifying the determined noise source device to the electronic device so that the electronic device controls operation of the noise source device to cause noise within the deep sleep range.

### DESCRIPTION OF DRAWINGS

FIG. 1 illustrates controlling a plurality of devices so a user may sleep, according to an embodiment of the disclosure;

FIG. 2 is a block diagram of an electronic device, according to an embodiment of the disclosure;

FIG. 3 is a flowchart illustrating a method of controlling a plurality of devices so a user may sleep, according to an embodiment of the disclosure;

FIG. 4 illustrates sleep information obtained for a control method, according to an embodiment of the disclosure;

FIG. 5 is a flowchart illustrating a method of obtaining and analyzing sleep information for a control method, according to an embodiment of the disclosure;

FIG. 6 illustrates determining a noise source device and controlling operation of a noise source device for a control method, according to an embodiment of the disclosure;

FIG. 7 is a flowchart illustrating determining a noise source device and controlling operation of a noise source device for a control method, according to an embodiment of the disclosure;

FIG. 8 is a flowchart illustrating controlling operation of a noise source device based on a sleep phase for a control method, according to an embodiment of the disclosure;

FIG. 9 illustrates a system for controlling a plurality of devices in real time so a user may sleep, according to an embodiment of the disclosure;

FIG. 10 is a flowchart illustrating a method of controlling a plurality of devices in real time so a user may sleep according to an embodiment of the disclosure;

FIG. 11 illustrates controlling a plurality of devices based on distances between a user and the plurality of devices according to an embodiment of the disclosure;

FIG. 12 is a flowchart illustrating a method of controlling a plurality of devices based on distances between a user and the plurality of devices according to an embodiment of the disclosure;

FIG. 13 illustrates controlling a plurality of devices based on noise caused from each of the plurality of devices and a distance from a user to each of the plurality of devices according to an embodiment of the disclosure;

FIG. 14 is a flowchart illustrating a method of controlling a plurality of devices based on noise caused from each of the plurality of devices and a distance from a user to each of the plurality of devices according to an embodiment of the disclosure;

FIG. 15 illustrates a user interface (UI) indicating control of a plurality of devices so a user may sleep according to an embodiment of the disclosure; and

FIG. 16 illustrates a UI that helps with a user's sleep according to an embodiment of the disclosure.

### MODE FOR INVENTION

Terms as used herein will be briefly described, and an embodiment of the disclosure will now be described in detail.

The terms are selected as common terms that are currently widely used, taking into account principles of the disclosure, which may however depend on intentions of those of ordinary skill in the art, judicial precedents, emergence of new technologies, and the like. Some terms as used herein are selected at the applicant's discretion, in which case, the terms will be explained later in detail in connection with embodiments of the disclosure. Therefore, the terms should be defined based on their meanings and descriptions throughout the disclosure.

Throughout the disclosure, the expression “at least one of a, b or c” indicates only a, only b, only c, both a and b, both a and c, both b and c, all of a, b, and c, or variations thereof.

The term “include (or including)” or “comprise (or comprising)” is inclusive or open-ended and does not exclude additional, unrecited elements or method steps. The terms “unit”, “module”, “block”, etc., as used herein each represent a unit for handling at least one function or operation, and may be implemented in hardware, software, or a combination thereof.

An embodiment of the disclosure will now be described in detail with reference to accompanying drawings so as to be readily practiced by those of ordinary skill in the art. However, an embodiment of the disclosure may be implemented in many different forms, and is not limited to that discussed herein. In the drawings, parts unrelated to the description are omitted for clarity, and like numerals refer to like elements throughout the specification.

A method of controlling a plurality of devices so a user may sleep and an electronic device for performing the method according to the disclosure are to determine a noise source device that has influence over a change in sleep phase of the user.

The method of controlling a plurality of devices so the user may sleep and an electronic device for performing the method according to the disclosure are to provide a sleep noise environment customized for each user by controlling an operation mode of the determined noise source device in a low-nose mode suitable for the user.

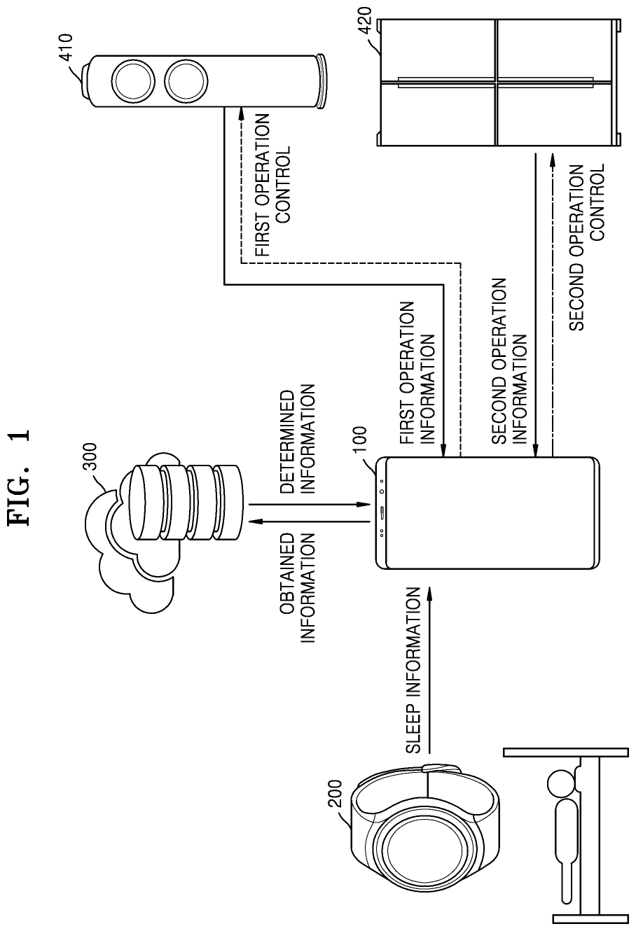

A system for controlling a plurality of devices so the user may sleep, according to the disclosure, will now be described in connection with FIG. 1.

FIG. 1 illustrates controlling a plurality of devices so a user may sleep according to an embodiment of the disclosure.

Referring to FIG. 1, an electronic device 100 may be a portable terminal, such as a smart phone, a tablet, or a notebook. It is not, however, limited thereto, and the electronic device 100 may be a data processing device that is able to perform operations and determinations to control the plurality of devices 410 and 420 so the user may sleep. The electronic device 100 may receive sleep information of the user. The electronic device 100 may receive the sleep information of the user from a wearable device 200 of the user.

The wearable device 200 may be a device worn by the user, such as a smart watch. It is not, however, limited thereto, and the wearable device 200 may be a biometric information sensing device for obtaining biometric information of the user. The wearable device 200 may obtain the user's sleep information from the user. The electronic device 200 may receive the sleep information of the user while the user is wearing the wearable device 200. The wearable device 200 may obtain sleep information input by the user to the wearable device 200. The wearable device 200 may store the obtained sleep information. The wearable device 200 may be paired with the electronic device 100. The wearable device 200 may send the stored sleep information to the electronic device 100.

The electronic device 100 may obtain sleep information by using each of the plurality of devices 410 and 420. At least one of the plurality of devices 410 and 420 may include a microphone. At least one of the plurality of devices 410 and 420 may use the microphone to obtain breathing sound of the user. The at least one of the plurality of devices 410 and 420 that obtains the breathing sound of the user with the microphone may transmit voice data corresponding to the breathing sound of the user to the electronic device 100. The electronic device 100 may receive the voice data corresponding to the breathing sound of the user from the at least one of the plurality of devices 410 and 420 that obtains the breathing sound of the user with the microphone. The electronic device 100 may obtain sleep information of the user based on the received voice data.

The electronic device 100 may include a microphone. The electronic device 100 may use the microphone to obtain breathing sound of the user. The electronic device 100 may obtain sleep information of the user based on the obtained breathing sound of the user.

The electronic device 100 may receive operation information of each of the plurality of devices 410 and 420. The plurality of devices 410 and 420 may be devices located and operating in the house, such as a house of the user. For example, the plurality of devices 410 and 420 may be a plurality of home appliances, such as an air conditioner 410, a refrigerator 420 and a television (TV) (not shown). The electronic device 100 may receive first operation information from the air conditioner 410 of the plurality of devices 410 and 420. The electronic device 100 may receive second operation information from the refrigerator 420 of the plurality of devices 410 and 420.

The sleep information of the user and the operation information of each of the plurality of devices 410 and 420 received by the electronic device 100 may be referred to as obtained information. The electronic device 100 may directly process the obtained information or transmit at least part of the obtained information to a server 300. When a case that the electronic device 100 directly processes the obtained information is possible and more efficient, the electronic device 100 may directly process the obtained information. When a case that the electronic device 100 directly processes the obtained information is impossible and less efficient, the electronic device 100 may transmit at least part of the obtained information to the server 300.

The server 300 may receive the at least part of the obtained information from the electronic device 100. The server 300 may process the received at least part of the obtained information. The server 300 may determine a noise source device among the plurality of devices 410 and 420 based on the at least part of the obtained information. The server 300 may transmit the determined information that includes the determined noise source device to the electronic device 100.

The electronic device 100 may determine a noise source device among the plurality of devices 410 and 420. The noise source device may be a device that causes noise outside a deep sleep range among the plurality of devices 410 and 420. The deep sleep range may be a noise range in which the user is able to keep sleeping. The noise source device may be a device that causes noise that disturbs the user's sleep. When a case that the electronic device 100 directly processes the obtained information is possible and more efficient, the electronic device 100 may directly process the obtained information to determine the noise source device. When a case that the electronic device 100 directly processes the obtained information is impossible and less efficient, the electronic device 100 may determine the noise source device based on the determined information received from the server 300.

The electronic device 100 may control operation of the noise source device so that noise from the determined noise source device belongs to the deep sleep range. The deep sleep range may be a noise range in which a sleep phase of the user is maintained and the user is able to keep sleeping. The deep sleep range may be a noise range that prevents a change in sleeping phase of the user. When the air conditioner 410 is determined as the noise source device among the plurality of devices 410 and 420, the electronic device 100 may perform first operation control on the air conditioner 410 so that the noise caused from the air conditioner 410 belongs to the deep sleep range. When the refrigerator 420 is determined as the noise source device among the plurality of devices 410 and 420, the electronic device 100 may perform second operation control on the refrigerator 420 so that the noise caused from the refrigerator 420 belongs to the deep sleep range. When both the air conditioner 410 and the refrigerator 420 of the plurality of devices 410 and 420 are determined as noise source devices, the electronic device 100 may perform the first operation control and the second operation control at the same time.

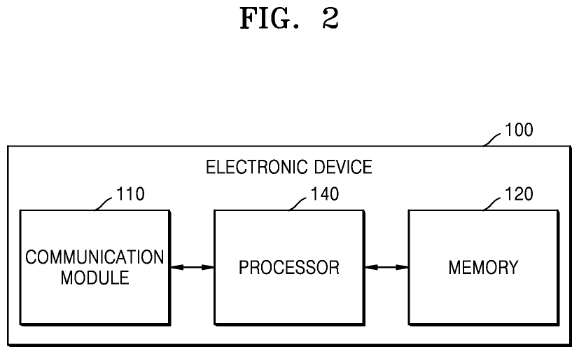

FIG. 2 is a block diagram of an electronic device according to an embodiment of the disclosure.

Referring to FIG. 2, in an embodiment of the disclosure, the electronic device 100 may include a communication module 110, memory 120 and a processor 140. It is not, however, limited thereto, and the electronic device 100 may further include a display for displaying a state of controlling a plurality of devices.

The communication module 110 may establish wireless communication connection with the wearable device 200, the server 300 and the plurality of devices 410 and 420. The communication module 110 may transmit or receive data and information to or from the wearable device 200, the server 300 and the plurality of devices 410 and 420. The communication module 110 may include a short-range communication circuit and a long-range communication circuit.

In an embodiment of disclosure, the short-range communication circuit may support near field communication (NFC) communication, Bluetooth (IEEE 802.15.1) communication, Bluetooth low energy (BLE) communication, wireless local area network (WLAN) communication, Zigbee communication, infrared data association (IrDA) communication, wireless fidelity (Wi-Fi) direct (WFD) communication, ultra wideband (UWB) communication, or Ant+ communication. The short-range communication circuit may perform short-range communication with the wearable device 200 and the plurality of devices 410 and 420.

In an embodiment of the disclosure, the long-range communication circuit may support a wireless communication network. The network may include a wide area network (WAN), such as the Internet, or a local area network (LAN) formed around an access point (AP). The long-range communication circuit may perform wireless communication with the server 300. The long-range communication circuit may transmit or receive a wireless signal to or from the server 300 over a mobile communication network. The wireless signal may include a voice call signal, a video call signal or different types of data involved in transmission/reception of a text/multimedia message. The long-range communication circuit may include a 3^{rd} generation (3G) module, a 4^{th} generation (4G) module, a long term evolution (LTE) module, a 5^{th} generation (5G) module, a sixth generation (6G) module, a narrow band (NB) Internet of things (IoT) module, an LTE machine type communication (LTE-M) module, or the like, without being limited thereto.

The memory 120 may include at least one type of storage medium including flash memory, a hard disk, multimedia card micro type memory, card type memory (e.g., secure digital (SD) or extreme digital (XD) memory), random access memory (RAM), static random access memory (SRAM), read-only memory (ROM), electrically erasable programmable read-only memory (EEPROM), programmable ROM (PROM), magnetic memory, magnetic disk, and optical disk. The memory 120 may store information received by the electronic device 100. The memory 120 may store a program. The program may be used by the processor 140 to process information.

The processor 140 may control general operation of the electronic device 100. The processor 140 may directly process the received sleep information and operation information of each of the plurality of devices 410 and 420. The processor 140 may determine to transmit at least part of the obtained information of the received sleep information and operation information of each of the plurality of devices 410 and 420 to the server 300. The processor 140 may receive the determined information from the server 300. The processor 140 may determine a noise source device based on a result of directly processing the received sleep information and operation information of each of the plurality of devices 410 and 420. The processor 140 may determine a noise source device based on the determined information received from the server 300. For example, the processor 140 may identify a noise source operation based on the determined information received from the server 300. The processor 140 may determine a device that is performing the identified noise source operation as a noise source device. The processor 140 may control operation of the noise source device so that noise caused from the determined noise source device belongs to the deep sleep range.

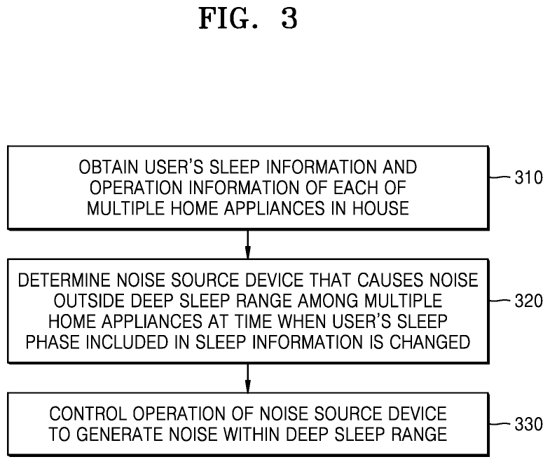

FIG. 3 is a flowchart illustrating a method of controlling a plurality of devices for a user's sleep according to an embodiment of the disclosure.

Referring to FIG. 3, in operation 310, the electronic device 100 may obtain sleep information of the user and operation information of each of the plurality of home appliances 410 and 420 in a house.

In an embodiment of the disclosure, the electronic device 100 may obtain the user's sleep information. The user's sleep information may include information about a sleeping phase of the user in a time zone. The sleeping phase may include a non-sleep (awake) phase, a rapid eye movement (REM) sleep phase, or a non-REM sleep phase. The sleep information may include a time when the user's sleep phase is changed. For example, the sleep information may include information indicating that the sleep phase of the user has changed from the non-sleep phase to the REM sleep phase at 1 a.m. The electronic device 100 may monitor the user's sleep state in real time to obtain information about the user's sleep phase. The electronic device 100 may learn the sleep information of the user. For example, the electronic device 100 may lean the user's sleep history to collect information about the user's sleep phase.

In an embodiment of the disclosure, the electronic device 100 may obtain operation information of each of the plurality of devices 410 and 420 located in the house. The operation information of each of the plurality of devices 410 and 420 may include information about what operation modes each of the plurality of devices 410 and 420 has. For example, the operation information of the air conditioner 410 of the plurality of devices 410 and 420 may include information indicating that the air conditioner 410 operates in one of a strong wind mode, a weak wind mode, a sleep operation mode, and a condensate discharge mode. For example, the operation information of the refrigerator 420 of the plurality of devices 410 and 420 may include information indicating that the refrigerator 420 operates in a power freezing mode, a compressor operation mode, or a saving mode. The electronic device 100 may learn the operation information of each of the plurality of devices 410 and 420 located indoors.

In an embodiment of the disclosure, the electronic device 100 may obtain device information of each of the plurality of devices 410 and 420 along with the operation information of each of the plurality of devices 410 and 420. The device information of each of the plurality of devices 410 and 420 may include information about a type of each of the plurality of devices 410 and 420 and information about a model name of each of the plurality of devices 410 and 420.

In an embodiment of the disclosure, the electronic device 100 may obtain noise information of each of the plurality of devices 410 and 420 along with the operation information of each of the plurality of devices 410 and 420. The noise information of each of the plurality of devices 410 and 420 may include information about loudness and frequency of the noise occurring while each of the plurality of devices 410 and 420 is operating. In operation 320, it is clear that a noise source device is determined by analyzing a sleepable range by using training.

In operation 320, the electronic device 100 may determine a noise source device which causes noise outside a deep sleep range among the plurality of home appliances 410 and 420 at a time when the user's sleep phase included in the sleep information is changed.

In an embodiment of the disclosure, the electronic device 100 may analyze the time when the user's sleep phase included in the sleep information is changed. In an embodiment of the disclosure, the electronic device 100 may determine the time when the user's sleep phase is changed based on the trained sleep information. The electronic device 100 may determine the time when the user's sleep phase is changed as a time at which the user's sleep is disturbed. For example, the electronic device 100 may determine a time at which the user's sleep phase is changed from the non-REM phase to the non-sleep phase as the time at which the user's sleep is disturbed. The electronic device 100 may learn the time when the user's sleep phase is changed by using a learning method, such as deep learning or machine learning.

In an embodiment of the disclosure, the electronic device 100 may analyze the noise caused from each of the plurality of devices 410 and 420 at the time when the user's sleep is disturbed based on the time when the user's sleep phase is changed. The electronic device 100 may determine an operation mode of each of the plurality of devices 410 and 420 at the time when the user's sleep is disturbed. The electronic device 100 may determine the loudness and frequency of the noise occurring in the operation mode of each of the plurality of devices 410 and 420 at the time when the user's sleep is disturbed.

In an embodiment of the disclosure, the electronic device 100 may determine a deep sleep range of the user. The deep sleep range may be a noise loudness range and a noise frequency range in which the user's sleep is not disturbed. The deep sleep range may be a noise range in which a sleep phase of the user is maintained and the user is able to keep sleeping. The deep sleep range may be a noise range that prevents a change in sleeping phase of the user. For example, the deep sleep range may be a range below a threshold variably set for each sub-frequency band within an audible frequency range. For example, in a case that the higher the noise frequency, the more frequently the user is awake, in the audible frequency band, 50 dB or less of noise may be in the deep sleep range in a low frequency band and 40 dB or less of noise may be in the deep sleep range in a high frequency band. The electronic device 100 may learn the deep sleep range of the user by using a learning method, such as deep learning or machine learning. In an embodiment of the disclosure, the electronic device 100 may determine the deep sleep range depending on the user's surroundings based on the operation information of each of the plurality of devices 410 and 420 at the time when the sleep phase is changed.

In an embodiment of the disclosure, the electronic device 100 may determine a noise source device among the plurality of devices 410 and 420 based on a result of analyzing the noise caused from each of the plurality of devices 410 and 420 and the deep sleep range of the user. The noise source device may be a device that causes noise outside the deep sleep range of the user. The electronic device 100 may determine whether the noise caused from each of the plurality of devices 410 and 420 deviates from the deep sleep range of the user. The electronic device 100 may determine which of the plurality of devices 410 and 420 operates while causing noise outside the deep sleep range of the user at the time when the user's sleep phase is changed. The electronic device 100 may determine one of the plurality of devices 410 and 420 that causes the noise outside the deep sleep range of the user at the time when the user's sleep phase is changed as the noise source device. The electronic device 100 may determine a noise source device by using a learning method, such as deep learning or machine learning.

In operation 330, the electronic device 100 may control operation of the noise source device so that noise caused from the noise source device occurs within the deep sleep range. The electronic device 100 may analyze a plurality of operation modes included in the operation information of the noise source device. The electronic device 100 may determine noise caused in each of the plurality of operation modes included in the operation information of the noise source device. In an embodiment of the disclosure, the electronic device 100 may control operation of the noise source device based on the trained sleep information and the operation information. The electronic device 100 may choose an operation mode in which noise belonging to the deep sleep range occurs from among the plurality of operation modes included in the operation information of the noise source device. For example, the electronic device 100 may control the noise source device to operate in a low-noise mode when the noise source device is operating in the low-noise mode and the noise caused from the noise source device belongs to the deep sleep range.

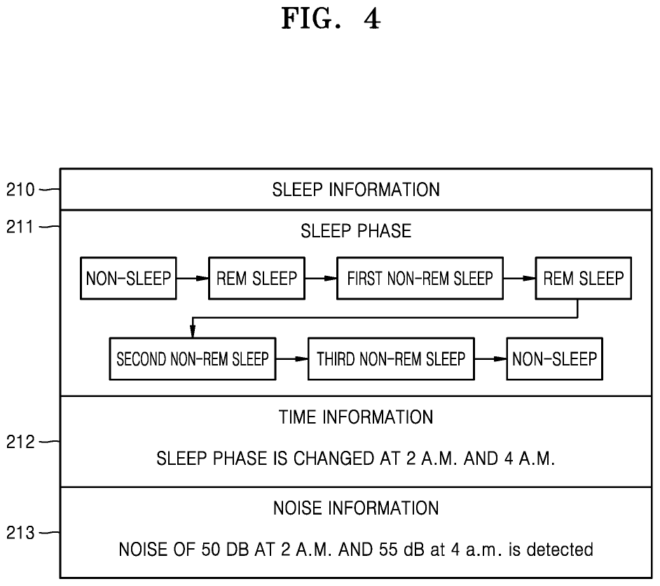

FIG. 4 illustrates sleep information obtained for a control method according to an embodiment of the disclosure.

Referring to FIG. 4, in an embodiment of the disclosure, the sleep information 210 may include a sleep phase 211. The electronic device 100 may monitor the sleep phase 211 of the user. The electronic device 100 may monitor the sleep phase 211 of the user by receiving information relating to the user's sleep. The information relating to the user's sleep may include at least one of the user's heart rate information, the user's breathing information, or the user's motion information. For example, the electronic device 100 may receive at least one of the user's heart rate information or the user's breathing information from the wearable device 200. For example, the electronic device 100 may obtain the user's motion information by using a sensor module including a gyro sensor. The electronic device 100 may determine to which phase of the non-sleep phase, the REM sleep phase, and the non-REM sleep phase the sleep phase 211 of the user belongs based on at least one of the user's heart rate information or the user's motion information. The electronic device 100 may determine to which phase of the non-sleep phase, the REM sleep phase, the non-REM sleep phase the sleep phase 211 of the user belongs based on the user's breathing information. For example, the sleep phase 211 may indicate that the user has taken sleep in the following sequence: non-sleep, REM sleep, first non-REM sleep, REM sleep, second non-REM sleep, third non-REM sleep and non-sleep.

In an embodiment of the disclosure, the sleep information 210 may include time information 212. The time information 212 may include information about a time when the sleep phase 211 of the user changed. For example, the time information 212 may include information indicating that the sleep phase 211 of the user changed at 2 a.m., and 4 a.m.

In an embodiment of the disclosure, the sleep information 210 may include noise information 213. The noise information 213 may include information about noise occurring at a time when the sleep phase 211 of the user changes. For example, the noise information 21 may include information indicating that a noise of 50 dB was detected at 2 a.m., and that a noise of 55 dB was detected at 4 a.m.

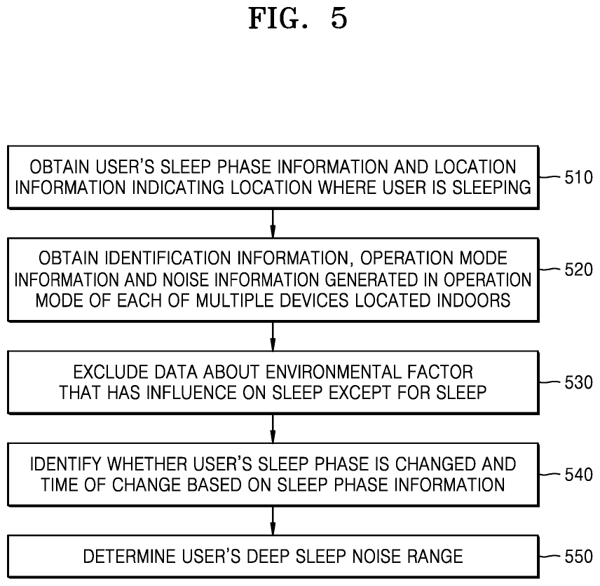

FIG. 5 is a flowchart illustrating a method of obtaining and analyzing sleep information for a control method according to an embodiment of the disclosure.

Referring to FIG. 5, it shows a method of training a sleep pattern of the user and storing the sleep pattern in the electronic device 100 or the server 300. FIG. 5 shows how to identify a time when the user's sleep phase is changed based on a result of training the user's sleep pattern.

In operation 510, the electronic device 100 may obtain sleep phase information of the user and location information indicating a location where the user is sleeping. The location information indicating the location where the user is sleeping may be represented by a spatial unit in the house, such as a living room, a first room or a second room.

In operation 520, the electronic device 100 may obtain identification information, operation mode information and information about noise caused in the operation mode of each of the plurality of devices 410 and 420 located indoors. The term indoors herein may refer to ‘in the house’. For example, indoors may refer to ‘in the user's house’. The terms indoors and in the house may be interchangeably used. The electronic device 100 may train device information and operation information for each time zone of each of the plurality of devices 410 and 420 located in the house. The electronic device 100 may obtain information about the loudness and frequency of the noise occurring when each of the plurality of devices 410 and 420 located in the house is operating in a certain operation mode. For example, the electronic device 100 may obtain information indicating that the air conditioner 410 of the plurality of devices 410 and 420 located in the house causes a noise of 70 dB in the strong-wind operation mode, 60 dB in the weak-wind operation mode, and 50 dB in the sleep operation mode.

In operation 530, the electronic device 100 may exclude data about environmental factors having influence on sleep except for noise. The electronic device 100 may search for a home appliance that disturbs the user's sleep based on the noise. The electronic device 100 may determine environmental factors except for the noise that disturbs the user's sleep as noise that interferes with the searching procedure.

In operation 540, the electronic device 100 may identify whether there is a change in sleep phase of the user and a time of the change based on the sleep phase information.

In operation 550, the electronic device 100 may determine a noise range that allows sound sleep of the user. The noise range that allows sound sleep of the user may include critical noise loudness. The noise range that allows sound sleep of the user may include critical noise loudness for each frequency band of the noise. The electronic device 100 may determine the noise range by determining the critical noise loudness. The electronic device 100 may determine the noise range by determining critical noise loudness for each frequency band of the noise. For example, the electronic device 100 may determine the noise range by multiplying the critical noise loudness value by a safety coefficient. For example, the electronic device 100 may determine the noise range by multiplying the critical noise loudness value for each frequency band of the noise by the safety coefficient.

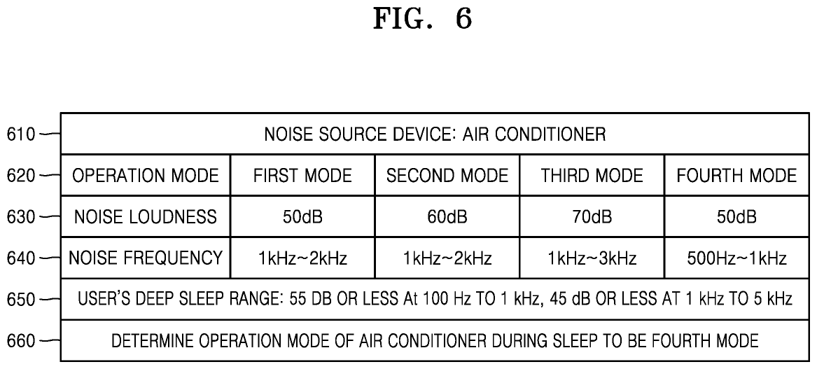

FIG. 6 illustrates determining a noise source device and controlling operation of a noise source device for a control method according to an embodiment of the disclosure.

Referring to FIG. 6, the electronic device 100 may generate noise source device information 610 to determine a noise source device. For example, the electronic device 100 may determine the air conditioner as the noise source device based on the noise source device information 610. The electronic device 100 may extract information about a time when the sleep phase is changed from sleep phase information accumulated for a set period. The electronic device 100 may analyze operation information of a home appliance at the time. The operation information of the home appliance may include noise information of the home appliance. The electronic device 100 may generate the noise source device information 610 based on the noise information of the home appliance.

The electronic device 100 may obtain operation mode information 620 relating to a plurality of operation modes of the noise source device. For example, the electronic device 100 may obtain the operation mode information 620 indicating that the noise source device has a first mode, a second mode, a third mode and a fourth mode.

The electronic device 100 may obtain operation mode information 620 relating to a plurality of operation modes of the noise source device. For example, the electronic device 100 may obtain the operation mode information 620 indicating that the noise source device has the first mode, the second mode, the third mode and the fourth mode.

The electronic device 100 may obtain noise loudness information 630 in each of the plurality of operation modes of the noise source device. For example, the electronic device 100 may obtain the noise loudness information 630 indicating that the noise source device causes a noise of 50 dB in the first mode, 60 dB in the second mode, 70 dB in the third mode and 50 dB in the fourth mode.

The electronic device 100 may obtain noise frequency information 640 in each of the plurality of operation modes of the noise source device. For example, the electronic device 100 may obtain the noise frequency information 640 indicating that the noise source device causes noise in a 1 kilohertz (KHz) to 2 KHz frequency band in the first mode, noise in a 1 KHz to 2 KHz frequency band in the second mode, noise in a 1 KHz to 3 KHz frequency band in the third mode, and noise in a 500 hertz (Hz) to 1 KHz frequency band in the fourth mode.

The electronic device 100 may obtain user's deep sleep range information 650. For example, the electronic device 100 may obtain the user's deep sleep range information 650 by training a sleep pattern of the user during a certain period. For example, the electronic device 100 may obtain the user's deep sleep range information 650 based on a result of analyzing the noise occurring at a time when the user's sleep phase is changed. For example, the electronic device 100 may obtain the deep sleep range information 650 by obtaining, for each time zone, the information about the noise loudness range and the noise frequency range in which the user is able to take sleep. For example, the electronic device 100 may obtain the deep sleep range information 650 by obtaining, for each season, the information about the noise loudness range and the noise frequency range in which the user is able to take sleep. For example, the electronic device 100 may obtain, for each temperature, the deep sleep range information 650 by obtaining the information about the noise loudness range and the noise frequency range in which the user is able to take sleep. For example, the electronic device 100 may obtain, for each humidity, the deep sleep range information 650 by obtaining the information about the noise loudness range and the noise frequency range in which the user is able to take sleep. For example, the electronic device 100 may obtain the deep sleep range information 650 including information indicating that the user's deep sleep range is 55 dB or less in 100 Hz to 1 KHz and 45 dB or less in 1 KHz to 5 KHz.

The electronic device 100 may generate operation control information 660 based on the operation mode information 620, the noise loudness information 630, the noise frequency information 640 and the deep sleep range information 650. For example, the electronic device 100 may determine based on the noise loudness information 630 and the noise frequency information 640 that operation of the air conditioner in the fourth mode belongs to the deep sleep range indicated by the deep sleep range information 650. The electronic device 100 may generate the operation control information 660 to determine the operation mode of the air conditioner in the user's sleep to be the fourth mode.

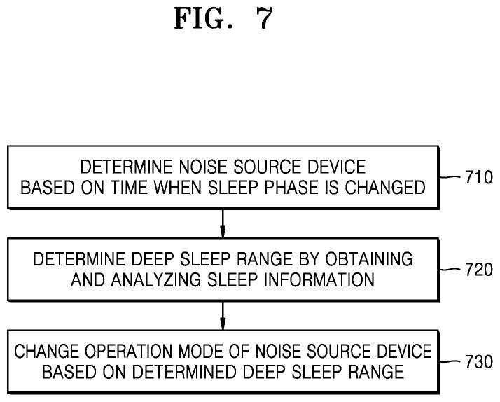

FIG. 7 is a flowchart illustrating determining a noise source device and controlling operation of the noise source device for a control method according to an embodiment of the disclosure.

Referring to FIG. 7, in operation 710, the electronic device 100 may determine a noise source device based on a time when a sleep phase is changed. The electronic device 100 may determine a noise source device that changes the user's sleep phase based on whether the sleep phase is changed and the time of the change. The electronic device 100 may obtain identification information and operation mode information of the determined noise source device.

In operation 720, the electronic device 100 may determine the deep sleep range by obtaining and analyzing the sleep information. The electronic device 100 may analyze the user's critical noise loudness and critical noise frequency included in the sleep information. The electronic device 100 may determine the user's deep sleep range based on the critical noise loudness and critical noise frequency.

In operation 730, the electronic device 100 may change the operation mode of the noise source device based on the determined deep sleep range. The electronic device 100 may change the operation mode of the noise source device depending on the sleep phase so that the noise caused from the noise source device in the user's sleep belongs to the deep sleep range.

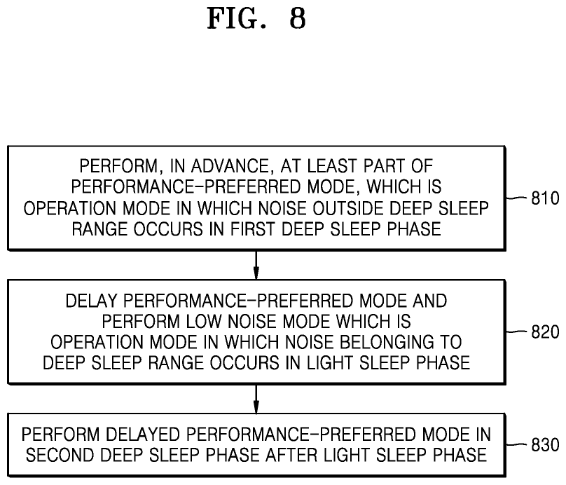

FIG. 8 is a flowchart illustrating controlling operation of a noise source device based on a sleep phase for a control method according to an embodiment of the disclosure.

Referring to FIG. 8, in operation 810, the electronic device 100 may control operation of the noise source device to perform, in advance, at least part of a performance-preferred mode which is an operation mode in which noise outside the deep sleep range is caused in a first deep sleep phase. The first deep sleep phase may correspond to the non-REM sleep phase of the user's sleep phase. The first deep sleep phase may be a phase in which sleep is not affected by normal sound generated from the home appliance. The performance-preferred mode may be a mode in which to preferentially secure the performance of the home appliance over the user's sleep. The performance-preferred mode may be a mode in which a presence of a sleeping person is not taken into account. For example, the performance-preferred mode may be a mode in which the air conditioner operates in a strong wind mode or the drain pump operates. For example, the performance-preferred mode may be a mode in which a compressor of the refrigerator operates. For example, the performance-preferred mode may be a mode in which a television (TV) outputs loud sound. The electronic device 100 may control operation of the noise source device to perform the performance-referred mode in advance in a first deep sleep phase when the noise source device is supposed to perform the performance-preferred mode at certain intervals.

In operation 820, the electronic device 100 may control operation of the noise source device to delay the performance-preferred mode in a light sleep phase and perform a low-noise mode, which is an operation mode in which to generate noise belonging to the deep sleep range. The light sleep phase may be adjacent to the non-sleep phase of the user's sleep phase. The light sleep phase may correspond to the REM sleep phase of the user's sleep phase. The light sleep phase may be a phase in which sleep is affected by normal sound generated from the home appliance. The low-noise mode may be a mode in which to preferentially consider keeping the user's sleep intact over the performance of the home appliance. The low-noise mode may be a mode with an assumption that there is a sleeping person. For example, the low-noise mode may be a mode in which the air conditioner operates in a weak wind mode or operation of the drain pump is suspended. For example, the performance-preferred mode may be a mode in which operation of a compressor of the refrigerator is suspended. For example, the performance-preferred mode may be a mode in which the TV operates in silence. The electronic device 100 may control the noise source device not to operate in the performance-preferred mode but to operate in the low-noise mode in the light sleep phase.

In operation 830, the electronic device 100 may perform the delayed performance-preferred mode in a second deep sleep phase after the right sleep phase. The electronic device 100 may control the noise source device to perform the performance-preferred mode in the second deep sleep phase that has not been performed in the light sleep phase.

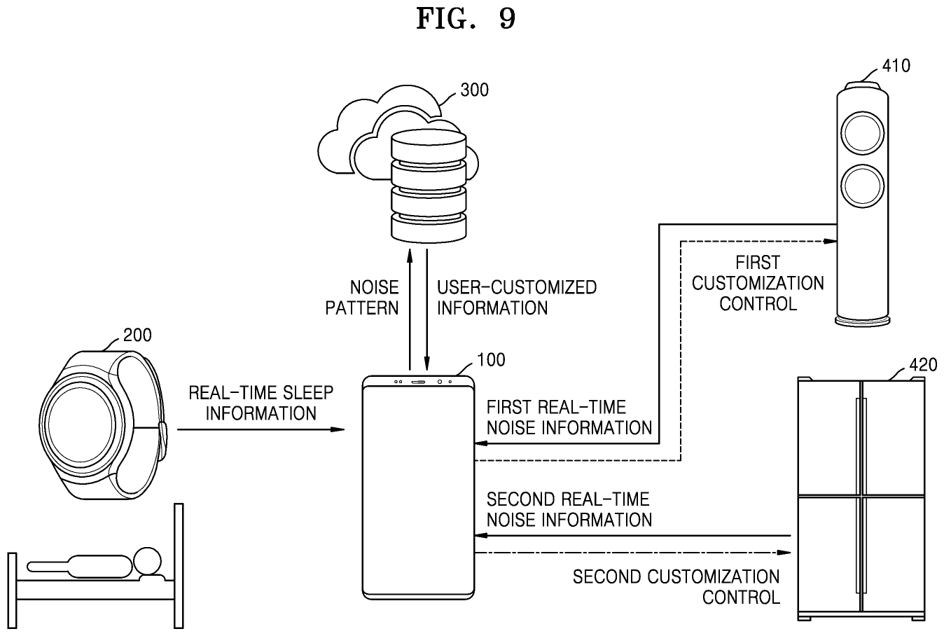

FIG. 9 illustrates a system for controlling a plurality of devices and in real time for a user's sleep according to an embodiment of the disclosure.

Referring to FIG. 9, the electronic device 100 may receive sleep information from the wearable device 200 of the user in real time.

The electronic device 100 may receive noise information of each of the plurality of devices 410 and 420 in real time. The electronic device 100 may receive first real-time noise information from the air conditioner 410 of the plurality of devices 410 and 420. The electronic device 100 may receive second real-time noise information from the refrigerator 420 of the plurality of devices 410 and 420.

The sleep information of the user and the real-time noise information of each of the plurality of devices 410 and 420 received by the electronic device 100 may be referred to as a noise pattern. The electronic device 100 may directly process the noise pattern or transmit at least part of the noise pattern to the server 300.

The server 300 may receive the at least part of the noise pattern from the electronic device 100. The server 300 may process the received at least part of the noise pattern. The server 300 may determine a noise source device among the plurality of devices 410 and 420 based on the at least part of the noise pattern. The server 300 may transmit user-customized information including the determined noise source device to the electronic device 100.

The electronic device 100 may determine a noise source device among the plurality of devices 410 and 420. The noise source device may be a device that causes noise outside a deep sleep range among the plurality of devices 410 and 420. The noise source device may be a device that causes noise that disturbs the user's sleep.

The electronic device 100 may control operation of the noise source device so that the noise caused from the determined noise source device occurs within the deep sleep range. When the air conditioner 410 is determined as the noise source device among the plurality of devices 410 and 420, the electronic device 100 may perform first customization control on the air conditioner 410 so that the noise caused from the air conditioner 410 belongs to the deep sleep range. When the refrigerator 420 is determined as the noise source device among the plurality of devices 410 and 420, the electronic device 100 may perform second customization control on the refrigerator 420 so that the noise caused from the refrigerator 420 belongs to the deep sleep range. When both the air conditioner 410 and the refrigerator 420 of the plurality of devices 410 and 420 are determined as noise source devices, the electronic device 100 may perform the first customization control and the second customization control at the same time.

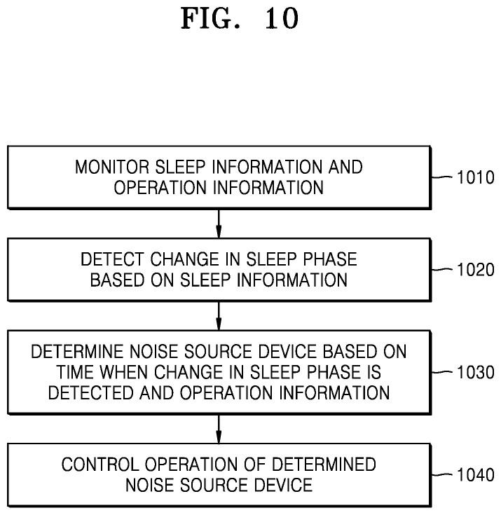

FIG. 10 is a flowchart illustrating a method of controlling a plurality of devices in real time for a user's sleep according to an embodiment of the disclosure.

Referring to FIG. 10, in operation 1010, the electronic device 100 may monitor sleep information and operation information. In an embodiment of the disclosure, the electronic device 100 may obtain, in real time, sleep information of the user and operation information of each of a plurality of devices in the house.

In operation 1020, the electronic device 100 may detect a change in sleep phase based on the sleep information. In an embodiment of the disclosure, the electronic device 100 may obtain a time when the user's sleep phase is changed based on the monitored sleep information.

In operation 1030, the electronic device 100 may determine a noise source device based on the detected time when the sleep phase is changed and the operation information. In an embodiment of the disclosure, the electronic device 100 may determine a device that disturbs the user's sleep based on the operation information of each of the plurality of devices at the time where the sleep phase is changed.

In operation 1040, the electronic device 100 may control operation of the determined noise source device. In an embodiment of the disclosure, the electronic device 100 may change the operation mode of the noise source device not to disturb the user's sleep.

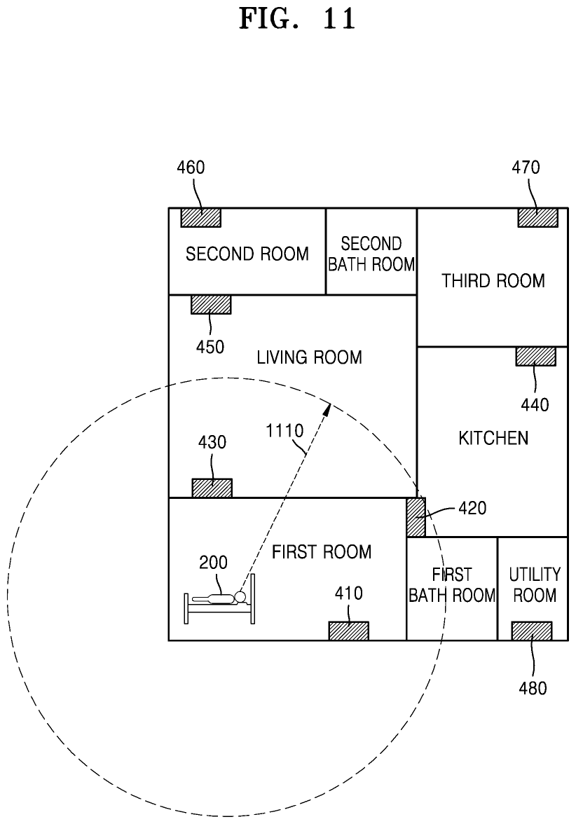

FIG. 11 illustrates controlling a plurality of devices based on distances between a user and plurality of devices according to an embodiment of the disclosure.

Referring to FIG. 11, in an embodiment of the disclosure, the electronic device 100 may obtain location information of the user (interchangeably used with the wearable device) 200. For example, when collecting sleep information of the user 200, the electronic device 100 may collect the user's sleep location information. In the case that the electronic device 100 collects the user's sleep location information, the electronic device 100 may generally determine that the user 200 is at the corresponding location while in sleep. The electronic device 10 may collect location information during the sleep by the unit of living room or room in the house. For example, the electronic device 100 may obtain the user's sleep location information and determine that the user usually takes sleep in the first room.

In an embodiment of the disclosure, the electronic device 100 may obtain location information of each of the plurality of devices 410 to 480. For example, when collecting information about home appliances in the house, the electronic device 100 may collect location information of each of the plurality of devices 410 to 480. The electronic device 100 may collect the location information of each of the plurality of devices 410 to 480 by the unit of living room or room in the house. For example, the electronic device 100 may determine that among the plurality of devices 410 to 480, the first device 410 is in the first room, the second device 420 is on a boundary between the first room and a kitchen, the third device 430 is in a living room and a fourth device 440 is in the kitchen. For example, the electronic device 100 may determine that among the plurality of devices 410 to 480, the fifth device 450 is in the living room, the sixth device 460 is in the second room, the seventh device 470 is in the third room and the eighth device 480 is in a utility room.

In an embodiment of the disclosure, the electronic device 100 may calculate a distance from the user 200 to each of the plurality of devices 410 to 480.

In an embodiment of the disclosure, the electronic device 100 may set a critical distance 1110 from a center of the user 200. The electronic device 100 may determine whether each of the plurality of devices 410 to 480 is within the critical distance 1110. For example, the critical distance 1110 may be set to be a distance determined by the user. For example, the critical distance 1110 may be set based on sleep sensitivity set by the user. For example, when the sleep sensitivity set by the user is high, the critical distance 1110 may be set to a longer distance than in a case that the sleep sensitivity set by the user is low.

In an embodiment of the disclosure, when detecting a change in the user's sleep phase, the electronic device 100 may determine a device that causes noise outside the deep sleep range, from among at least one device 410, 420 or 430 within the set critical distance 1110 as the noise source device. When determining the noise source device, the electronic device 100 may take into account noise caused from the at least one device 410, 420 or 430 within the critical distance 1110 among the plurality of devices 410 to 480. The electronic device 100 may determine the noise source device by obtaining noise information of the devices 410, 420 and 430 within the critical distance 1110 in the time zone where the user's sleep phase is changed. For example, the electronic device 100 may determine that the first device 410 of the devices 410, 420 and 430 within the critical distance 1110 causes noise outside the deep sleep range in the time zone where the user's sleep phase is changed, and determine the first device 410 as the noise source device.

In an embodiment of the disclosure, the electronic device 100 may control operation of the determined noise source device. For example, the electronic device 100 may control the first device 410 determined as the noise source device to generate noise within the deep sleep range.

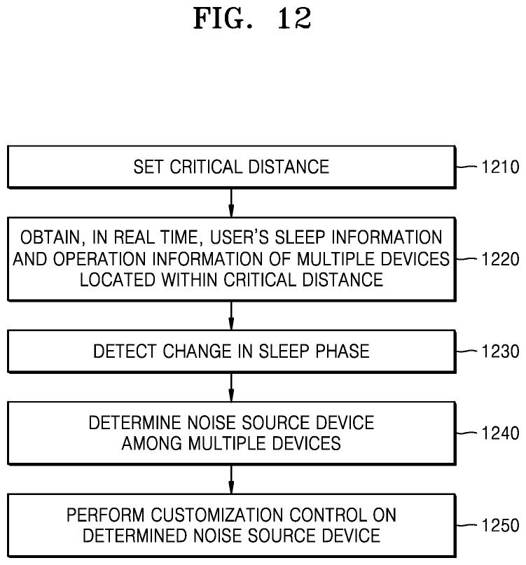

FIG. 12 is a flowchart illustrating a method of controlling a plurality of devices based on distances between a user and the plurality of devices according to an embodiment of the disclosure.

Referring to FIG. 12, in operation 1210, the electronic device 100 may set a critical distance. For example, the critical distance 1110 may be set as a distance set by the user. For example, the critical distance 1110 may be set based on sleep sensitivity set by the user. For example, when the sleep sensitivity set by the user is high, the critical distance 1110 may be set to a longer distance than in a case that the sleep sensitivity set by the user is low.

In operation 1220, the electronic device 100 may obtain sleep information of the user and operation information of the plurality of devices located within the critical distance in real time. In an embodiment of the disclosure, the electronic device 100 may monitor the sleep information and the operation information of at least one device within the critical distance. In an embodiment of the disclosure, the electronic device 100 may obtain the operation information of at least one of the plurality of devices of the user which is located within the critical distance.

In operation 1230, the electronic device 100 may detect a change in sleep phase. In an embodiment of the disclosure, the electronic device 100 may detect a time when the user's sleep phase is changed based on the sleep information.

In operation 1240, the electronic device 100 may determine a noise source device among the plurality of devices. In an embodiment of the disclosure, the electronic device 100 may determine the noise source device among at least one device located within the critical distance. In an embodiment of the disclosure, the electronic device 100 may analyze the operation information of the at least one device within the critical distance at a time when the sleep phase is changed. In an embodiment of the disclosure, the electronic device 100 may determine the noise source device that disturbs the user's sleep among the at least one device based on a result of the analyzing. For example, the electronic device 100 may determine at least one device that causes noise having at least a certain loudness value defined by the manufacturer as the noise source device. For example, the electronic device 100 may determine at least one device that causes noise having a noise value set by the user as the noise source device. For example, when there is one device that causes noise having at least a value defined by the manufacturer or set by the user among at least one device located within the critical device, the electronic device 100 may determine the one device as the noise source device.

In operation 1250, the electronic device 100 may perform customized control on the determined noise source device. In an embodiment of the disclosure, the electronic device 100 may control operation of the determined noise source device to be suitable for the user's deep sleep. In an embodiment of the disclosure, the electronic device 100 may change the operation mode of the noise source device not to disturb the user's sleep.

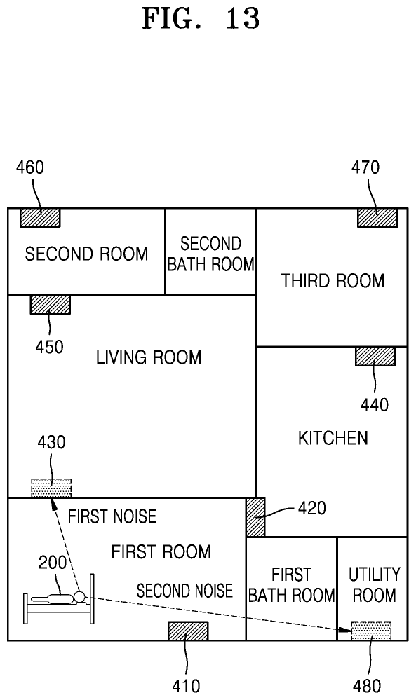

FIG. 13 illustrates controlling a plurality of devices based on noise caused from each of the plurality of devices and a distance from a user to each of the plurality of devices according to an embodiment of the disclosure.

Referring to FIG. 13, the electronic device 100 may control the home appliance by taking into account both a level of noise caused from each of the plurality of home appliances 410 to 480 and the distance to each of the plurality of home appliances 410 to 480. In this case, which of the plurality of devices is the noise source device that causes a change in sleep phase may be determined without prior training of the device information and operation information of the noise source device that changes the user's sleep phase.

In an embodiment of the disclosure, the user may input a type and location of a home appliance in the house on a map. The user may input a type and location of a home appliance in the house to a home appliance control application stored on the electronic device 100. The input type and location information of the home appliance in the house may be stored in the memory 120 of the electronic device 100 or a storage space of the server 300. The user's sleep phase may be monitored with a wearable device.

In an embodiment of the disclosure, each of the plurality of home appliances 410 to 480 may include a microphone. The microphone of each of the plurality of home appliances 410 to 480 may collect noise information of each of the plurality of home appliances 410 to 480 when the home appliance is operating. The electronic device 100 may obtain noise information of each of the plurality of home appliances 410 to 480 collected through the microphone of the home appliance. The electronic device 100 may monitor a noise level of each of the plurality of home appliances 410 to 480 through the noise information of each of the plurality of home appliances 410 to 480.

The electronic device 100 may determine at least one of home appliances that operate when the user's sleep phase is changed as the noise source device. For example, when one home appliance is operating when the user's sleep phase is changed, the electronic device 100 may determine the device as the noise source device and control the device to produce low noise. For example, when one or more 410 and 430 of the plurality of home appliances 410 to 480 are operating when the user's sleep phase is changed, the electronic device 100 may determine a noise source device that has changed the user's sleep phase based on a level of noise caused from each of the one or more home appliances 410 and 430 and a distance from each of the one or more home appliances 410 and 430 to the user. For example, when the third and eighth 430 and 480 of the plurality of home appliances 410 to 480 are operating when the user's sleep phase is changed, the electronic device 100 may determine the noise source device to be the third device 430 based on information indicating that first noise was caused from the third device 430 and second noise from the eighth device 480, a distance from the third device 430 to the user and a distance from the eighth device 480 to the user. The electronic device 100 may control the third device 430 determined as the noise source device to operate in the low-noise mode.

In an embodiment of the disclosure, there may be a microphone located in the room where the user is sleeping. The electronic device 100 may take into account a noise level collected through the microphone located in the room where the user is sleeping. The electronic device 100 may determine the noise source device that disturbs the user's sleep by taking into account the noise level collected through the microphone located in the room where the user is sleeping.

In an embodiment of the disclosure, based on noise caused in operation, a surrounding condition and a distance of each of the plurality of home appliances 410 to 480, noise information reaching the user may be trained through the microphone located in the room where the user is sleeping. For example, based on whether the surroundings where each of the plurality of home appliances 410 to 480 is arranged is adjacent to a wall or a door in the house, the information of the noise to reach the user may change. The electronic device 100 may determine the noise source device based on a result of training through the microphone located in the room where the user is sleeping.

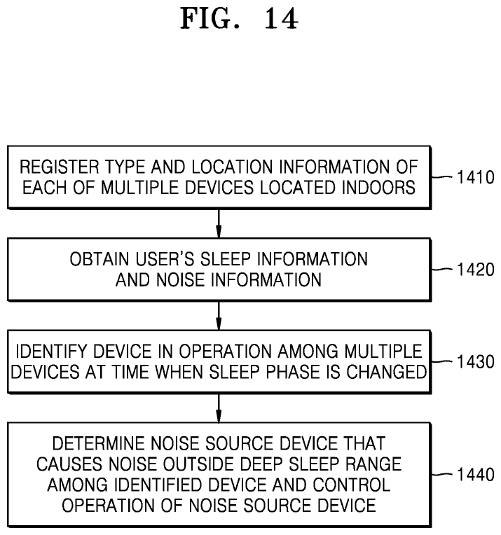

FIG. 14 is a flowchart illustrating a method of controlling a plurality of devices based on noise caused from each of the plurality of devices and a distance from a user to each of the plurality of devices according to an embodiment of the disclosure.

Referring to FIG. 14, in operation 1410, the electronic device 100 may register type and location information of each of the plurality of devices located indoors.

In operation 1420, the electronic device 100 may obtain sleep information of the user and noise information.

In operation 1430, the electronic device 100 may identify a device in operation among the plurality of devices at a time when the sleep phase is changed.

In operation 1440, the electronic device 100 may determine the noise source device that causes noise outside the deep sleep range, from among the identified devices, and control operation of the noise source device.

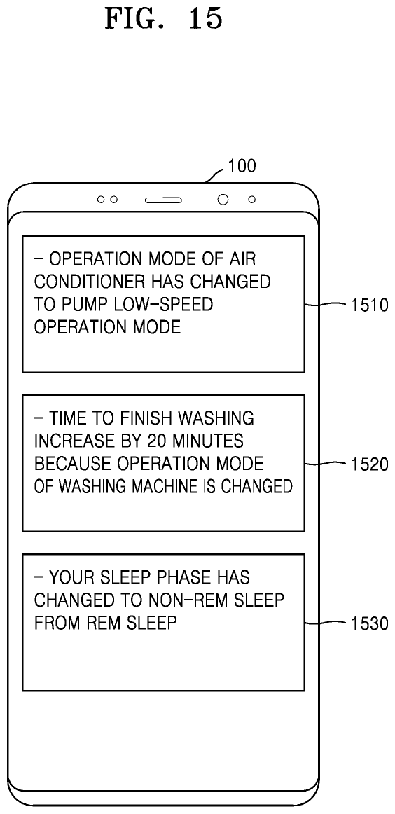

FIG. 15 illustrates a user interface (UI) indicating control of a plurality of devices for a user's sleep according to an embodiment of the disclosure.

Referring to FIG. 15, in an embodiment of the disclosure, the electronic device 100 may indicate, through a display, information about the determined noise source device and information indicating that operation of the determined noise source device is to be controlled. For example, the electronic device 100 may display a first notification UI 1510, a second notification UI 1520 and a third notification UI 1530.

In an embodiment of the disclosure, the electronic device 100 may display a content about determining of a sleeper-customized sleep mode through the first notification UI 1510. The electronic device 100 may provide user notification through the first notification UI 1510 to monitor the user. The electronic device 100 may display user sleep information, user's sleep phase monitoring information, user's deep sleep range, noise source device information, operation information of the noise source device and changed operation information of the noise source device through the first notification UE 1510. For example, the electronic device 100 may show that the air conditioner is the noise source device and controlled in the low-noise mode by displaying an indication, such as “the operation mode of the air conditioner has changed to a pump low-speed operation mode” through the first notification UI 1510.

In an embodiment of the disclosure, the electronic device 100 may show a result of the changed operation of the noise source device through the second notification UI 1520. For example, the electronic device 100 may show a result of a changed operation of a washing machine through the second notification UI 1520, such as “time to finish washing increases by 20 minutes because the operation mode of the washing machine is changed”.

In an embodiment of the disclosure, the electronic device 100 may perform feedback control through the third notification UI 1530. The electronic device 100 may keep monitoring the user's sleep phase to optimally modify the user-customized sleep mode and provide feedback though the third notification UI 1530. For example, the electronic device 100 may show that the user's sleep phase is being monitored in real time and the home appliances are managed not to disturb the user's sleep by displaying an indication, such as “your sleep phase has changed to the non-REM sleep from the REM sleep” through the third notification UI 1530.

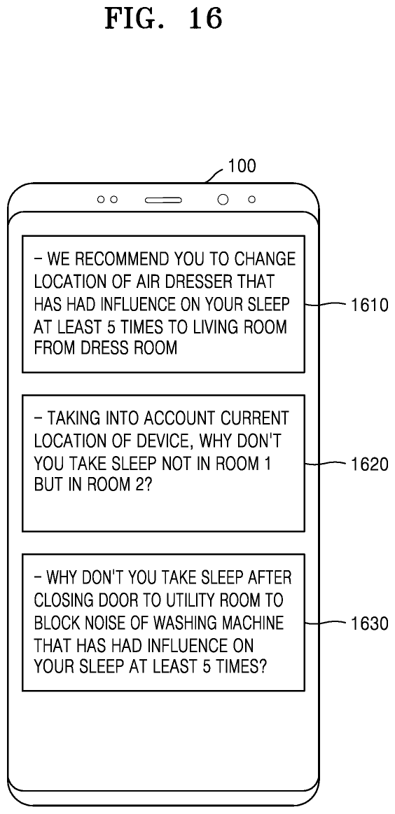

FIG. 16 illustrates a UI that helps a user's sleep according to an embodiment of the disclosure.

Referring to FIG. 16, in an embodiment of the disclosure, the electronic device 100 may generate a proposal for deep sleep for the user by combining the user's sleep phase monitoring information, the user's deep sleep range, the noise source device information, or the like, through the display. For example, the electronic device 100 may display a first proposal UI 1610, a second proposal UI 1620 and a third proposal UI 1630.

In an embodiment of the disclosure, the electronic device 100 may suggest a change of the location of the noise source device in the house that has had influence on the user certain times or more through the first proposal UI 1610. For example, the electronic device 100 may display a proposal, such as “we recommend you to change the location of the air dresser that has had influence on your sleep at least 5 times to the living room from the dress room” through the first proposal UI 1610.

In an embodiment of the disclosure, the electronic device 100 may recommend a location for the user's sleep based on the location of the noise source device that has had influence on the user's sleep certain times or more through the second proposal UI 1620. For example, the electronic device 100 may display a proposal, such as “taking into account the current locations of the devices, why don't you take sleep not in room 1 but in room 2?” through the second proposal UI 1620.

In an embodiment of the disclosure, the electronic device 100 may lead a noise reduction behavior based on the location of the noise source device that has had influence on the user certain times or more through the third proposal UI 1630. For example, the electronic device 100 may display a proposal, such as “why don't you take sleep after closing the door to the utility room to block the noise of the washing machine that has had influence on your sleep at least 5 times?” through the third proposal UI 1630. For example, the electronic device 100 may recommend a sleep aid that supports a noise canceling function for the user through the third proposal UI 1630.

According to an embodiment of the disclosure, a method of controlling a home appliance may include obtaining the user's sleep information and operation information of each of the plurality of home appliances 410 and 420 in the house. The method may include determining a noise source device which causes noise outside a deep sleep range, from among the plurality of home appliances 410 and 420 at a time when the user's sleep phase included in the sleep information is changed. The method may include controlling operation of the noise source device so that noise caused from the noise source device occurs within the deep sleep range.

The obtaining of the sleep information and operation information may include obtaining noise information generated from each of the plurality of home appliances 410 and 420 in an operation mode of each of the plurality of home appliances 410 and 420.

The obtaining of the sleep information and operation information may include excluding data about environmental factors which have influence on the user's sleep except for noise.

The determining of the noise source device may include identifying identification information and operation mode information of the noise source device that changes the sleep phase 211. The determining of the noise source device may include determining a user's deep sleep range based on at least one of user's critical noise loudness or critical noise frequency.

The controlling of the operation of the noise source device may include controlling the noise source device to perform in advance at least part of a performance-preferred mode in which the noise outside the deep sleep range is caused in a first sleep phase.

The obtaining of the sleep information and operation information may include monitoring the sleep information and the operation information in real time. The obtaining of the sleep information and operation information may include determining a time when the user's sleep phase is changed based on the sleep information monitored in real time.

The method may further include obtaining, in real time, operation information of at least one device 410 or 430 located within the critical distance 1110 that may affect the user's sleep from the user among the plurality of home appliances 410 to 480. The method may further include determining a deep sleep range based on the obtained operation information. The method may further include controlling operation of the at least one device 410 or 430 located within the critical distance based on the determined deep sleep range.

The method may further include registering type and location information of each of the plurality of devices 410 to 480. The method may further include identifying at least one 430 or 480 of the plurality of devices 410 to 480 which is operating at a time when the user's sleep phase is changed. The method may further include determining a noise source device among the identified at least one device 430 or 480 and controlling operation of the noise source device.

The method may further include outputting at least one notification UI 1510, 1520 or 1530 which indicates control of the noise source device.

The method may further include outputting at least one proposal UI 1610, 1620 or 1630 which includes guide information relating to an operation or placement of a home appliance to prevent sleep disturbance in relation to the noise source device.

The electronic device 100 may include the memory 120 for storing at least one instruction, and the at least one processor 140 for executing the at least one instruction. The at least one processor 140 may obtain sleep information of the user and operation information of each of the plurality of home appliances 410 and 420 in the house through the communication module 110. The at least one processor 140 may determine a noise source device which causes noise outside the deep sleep range, from among the plurality of home appliances 410 and 420 at a time when the user's sleep phase included in the sleep information is changed. The at least one processor 140 may control operation of the noise source device so that noise caused from the noise source device occurs within the deep sleep range.

The at least one processor 140 may obtain noise information generated from each of the plurality of devices 410 and 420 in an operation mode of each of the plurality of devices 410 and 420.

The at least one processor 140 may exclude data about environmental factors having influence on the user's sleep except for noise.

The at least one processor 140 may identify identification information and operation mode information of the noise source device that changes the sleep phase 211. The at least one processor 140 may determine the user's deep sleep range based on the user's critical noise loudness and critical noise frequency.

The at least one processor 140 may control the noise source device to perform in advance at least part of a performance-preferred mode in which the noise outside the deep sleep range is caused in a first sleep phase.

The at least one processor 140 may monitor the sleep information and the operation information in real time. The at least one processor 140 may determine a time when the user's sleep phase is changed based on the sleep information monitored in real time.

The at least one processor 140 may obtain, in real time, operation information of at least one device 410 or 430 located within the critical distance 1110 that may affect the user's sleep from the user among the plurality of devices 410 to 480. The at least one processor 140 may determine a deep sleep range based on the obtained operation information. The at least one processor 140 may control operation of the at least one device 410 or 430 located within the critical distance based on the determined deep sleep range.

The at least one processor 140 may register type and location information of each of the plurality of devices 410 to 480. The at least one processor 140 may identify the at least one 430 or 480 of the plurality of devices 410 to 480 which is operating at a time when the user's sleep phase is changed. The at least one processor 140 may determine a noise source device among the identified at least one device 430 or 480 and control operation of the noise source device.

The at least one processor 140 may control a display of the electronic device 100 to output at least one notification UI 1510, 1520 or 1530 which indicates control of the noise source device.

The at least one processor 140 may control the display of the electronic device 100 to output at least one proposal UI 1610, 1620 or 1630 which includes guide information relating to an operation or placement of a home appliance to prevent sleep disturbance in relation to the noise source device.

According to an embodiment of the disclosure, the server 300 may receive, from the electronic device 100, obtained information including at least part of sleep information of a user and operation information of each of the plurality of home appliances 410 or 420 in the house. The server 300 may determine a noise source device which causes noise outside the deep sleep range, from among the plurality of home appliances 410 and 420 at a time when the user's sleep phase included in the sleep information is changed based on the received obtained information. The server 300 may send the determined information to the electronic device 100 to control operation of the noise source device to generate noise within the deep sleep range.

The server 300 may obtain noise information generated from each of the plurality of devices 410 and 420 in an operation mode of each of the plurality of devices 410 and 420.

The server 300 may exclude data about environmental factors having influence on sleep except for noise.

The server 300 may identify identification information and operation mode information of the noise source device that changes the sleep phase 211. The server 300 may determine the user's deep sleep range based on the user's critical noise loudness and critical noise frequency.

The server 300 may control the noise source device to perform in advance at least part of the performance-preferred mode in which noise outside the deep sleep range is caused in the first deep sleep phase.

The server 300 may monitor sleep information and the operation information in real time. The server 300 may determine a time when the user's sleep phase is changed based on the sleep information monitored in real time.

The server 300 may obtain, in real time, operation information of at least one device 410 or 430 located within the critical distance 1110 that may affect the user's sleep from the user among the plurality of devices 410 to 480. The server 300 may determine a deep sleep range based on the obtained operation information. The server 300 may control operation of the at least one device 410 or 430 located within the critical distance based on the determined deep sleep range.

The server 300 may register type and location information of each of the plurality of devices 410 to 480. The server 300 may identify the at least one 430 or 480 of the plurality of devices 410 to 480 which is operating at a time when the user's sleep phase is changed. The server 300 may determine a noise source device among the identified at least one device 430 or 480 and control operation of the noise source device.

The server 300 may control the display of the electronic device 100 to output the at least one notification UI 1510, 1520 or 1530 which indicates control of the noise source device.

The server 300 may control the display of the electronic device 100 to output the at least one proposal UI 1610, 1620 or 1630 which includes guide information relating to an operation or placement of a home appliance to prevent sleep disturbance in relation to the noise source device.

According to the disclosure, a method of controlling home appliances and electronic device for performing the method may determine a noise source device based on a sleep pattern of a target sleeper and control the plurality of home appliances to be suitable for the sleeper, thereby more firmly securing the sleeper's sleep.

Furthermore, according to the disclosure, the method of controlling home appliances and electronic device for performing the method may alleviate unnecessary restriction of use of the home appliance by figuring out the noise source device that substantially affects the sleeper's sleep and controlling the operation.

The method according to an embodiment of the disclosure may be implemented in program instructions which are executable by various computing means and recorded in computer-readable media. The computer-readable media may include program instructions, data files, data structures, or the like, separately or in combination. The program instructions recorded on the computer-readable media may be designed and configured specially for the disclosure, or may be well-known to those of ordinary skill in the art of computer software. Examples of the computer readable recording medium include a magnetic medium, such as a hard disk, a floppy disk and a magnetic tape, an optical medium, such as compact disc read-only memory (CD-ROM) and a digital versatile disc (DVD), a magneto-optical medium, such as a floptical disk, and a hardware device specially configured to store and perform program instructions, such as read-only memory (ROM), random-access memory (RAM), flash memory, or the like. Examples of the program instructions include not only machine language codes but also high-level language codes which are executable by various computing means using an interpreter.

Some embodiments of the disclosure may be implemented in the form of a computer-readable recording medium that includes computer-executable instructions, such as the program modules executed by the computer. The computer-readable medium may be an arbitrary available medium that may be accessed by the computer, including volatile, non-volatile, removable, and non-removable mediums. The computer-readable recording medium may also include a computer storage medium and a communication medium. The computer-readable medium includes all the volatile, non-volatile, removable, and non-removable mediums implemented by an arbitrary method or technology for storage of information, such as computer-readable instructions, data structures, program modules, or other data. The communication medium generally includes computer-readable instructions, data structures, program modules, or other data or other transmission mechanism for modulated data signals like carrier waves, and include arbitrary information delivery medium. Furthermore, some embodiments of the disclosure may be implemented in a computer program or a computer program product including computer-executable instructions.

The machine-readable storage medium may be provided in the form of a non-transitory storage medium. The term ‘non-transitory storage medium’ may mean a tangible device without including a signal, e.g., electromagnetic waves, and may not distinguish between storing data in the storage medium semi-permanently and temporarily. For example, the non-transitory storage medium may include a buffer that temporarily stores data.

In an embodiment of the disclosure, the aforementioned method according to the various embodiments of the disclosure may be provided in a computer program product. The computer program product may be a commercial product that may be traded between a seller and a buyer. The computer program product may be distributed in the form of a machine-readable storage medium (e.g., a CD-ROM) or distributed directly between two user devices (e.g., smart phones) or online (e.g., downloaded or uploaded). In the case of the online distribution, at least part of the computer program product (e.g., a downloadable app) may be at least temporarily stored or arbitrarily created in a storage medium that may be readable to a device, such as a server of the manufacturer, a server of the application store, or a relay server.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method of controlling a home appliance, the method comprising:
obtaining sleep information of a user and operation information of each of a plurality of home appliances;
determining a noise source device which causes noise outside a deep sleep range, from among the plurality of home appliances, at a time when a sleep phase of the user included in the sleep information is changed; and
controlling operation of the noise source device so that noise caused from the noise source device is generated within the deep sleep range.

2. The method of claim 1, wherein the obtaining of the sleep information and the operation information comprises obtaining noise information caused from each of the plurality of home appliances in an operation mode of each of the plurality of home appliances.

3. The method of claim 1, wherein the obtaining of the sleep information and the operation information comprises excluding data about environmental factors which affect sleep of the user, except for noise.

4. The method of claim 1, wherein the determining of the noise source device comprises:
identifying identification information and operation mode information of the noise source device which changes the sleep phase; and
determining the deep sleep range of the user based on at least one of critical noise loudness or critical noise frequency of the user.

5. The method of claim 1, wherein the controlling of the noise source device comprises controlling the noise source device to perform, in advance, at least part of a performance-preferred mode in which noise outside the deep sleep range occurs in a first sleep phase.

6. The method of claim 1, wherein the obtaining of the sleep information and the operation information comprises:
monitoring the sleep information and the operation information in real time; and
determining a time when the sleep phase of the user is changed based on the sleep information monitored in real time.

7. The method of claim 1, further comprising:
obtaining, in real time, operation information of at least one device located within a critical distance likely to affect sleep of the user from the user among the plurality of home appliances;
determining the deep sleep range based on the obtained operation information; and
controlling operation of the at least one device located within the critical distance based on the determined deep sleep range.

8. The method of claim 1, further comprising:
registering type and location information of each of a plurality of devices;
identifying the at least one of the plurality of devices which is operating at the time when sleep phase of the user is changed; and
determining the noise source device among the identified at least one device and controlling operation of the noise source device.

9. The method of claim 1, further comprising outputting at least one notification user interface (UI) which indicates control of the noise source device.

10. The method of claim 1, further comprising outputting at least one proposal UI which includes guide information relating to an operation or placement of a home appliance to prevent sleep disturbance in relation to the noise source device.

11. An electronic device comprising:
a communication module;
memory storing one or more computer programs; and
one or more processors communicatively coupled to the communication module and the memory,
wherein the one or more computer programs include computer-executable instructions that, when executed by the one or more processors, cause the electronic device to:
obtain sleep information of a user and operation information of each of a plurality of home appliances in a house, through the communication module,
determine a noise source device which causes noise outside a deep sleep range, from among the plurality of home appliances, at a time when a sleep phase of the user included in the sleep information is changed, and
control operation of the noise source device so that noise caused from the noise source device occurs within the deep sleep range.

12. The electronic device of claim 11, wherein the one or more computer programs further include computer-executable instructions that, when executed by the one or more processors, cause the electronic device to obtain noise information generated from each of a plurality of devices in an operation mode of each of the plurality of devices.

13. The electronic device of claim 12, wherein the one or more computer programs further include computer-executable instructions that, when executed by the one or more processors, cause the electronic device to exclude data about environmental factors which affect sleep of the user, except for noise.

14. The electronic device of claim 11, wherein the one or more computer programs further include computer-executable instructions that, when executed by the one or more processors, cause the electronic device to:
identify identification information and operation mode information of the noise source device which changes the sleep phase, and
determine the deep sleep range of the user based on critical noise loudness and critical noise frequency of the user.

15. The electronic device of claim 11, wherein the one or more computer programs further include computer-executable instructions that, when executed by the one or more processors, cause the electronic device to control the noise source device to perform, in advance, at least part of a performance-preferred mode in which noise outside the deep sleep range occurs in a first sleep phase.

16. The electronic device of claim 11, wherein the one or more computer programs further include computer-executable instructions that, when executed by the one or more processors, cause the electronic device to:
monitor the sleep information and the operation information in real time, and
determine a time when the sleep phase of the user is changed based on the sleep information monitored in real time.

17. The electronic device of claim 11, wherein the one or more computer programs further include computer-executable instructions that, when executed by the one or more processors, cause the electronic device to:
obtain, in real time, operation information of at least one device located within a critical distance likely to affect sleep of the user from the user among the plurality of home appliances,
determine the deep sleep range based on the obtained operation information, and
control operation of the at least one device located within the critical distance based on the determined deep sleep range.

18. The electronic device of claim 11, wherein the one or more computer programs further include computer-executable instructions that, when executed by the one or more processors, cause the electronic device to:
register type and location information of each of a plurality of devices,
identify the at least one of the plurality of devices which is operating at the time when sleep phase of the user is changed, and
determine the noise source device among the identified at least one device and control operation of the noise source device.

19. The electronic device of claim 11, wherein the one or more computer programs further include computer-executable instructions that, when executed by the one or more processors, cause the electronic device to control a display of the electronic device to output at least one notification user interface (UI) which indicates control of the noise source device.

20. A server comprising:
a communication module;
memory storing one or more computer programs; and
one or more processors communicatively coupled to the communication module and the memory,
wherein the one or more computer programs include computer-executable instructions that, when executed by the one or more processors, cause the server to:
receive, from an electronic device, obtained information including at least part of sleep information of a user and operation information of each of a plurality of home appliances in a house,
determine, based on the received obtained information, a noise source device which causes noise outside a deep sleep range, from among the plurality of home appliances, at a time when a sleep phase of the user included in the sleep information is changed, and
send information identifying the determined noise source device to the electronic device so that the electronic device controls operation of the noise source device to cause noise within the deep sleep range.
